(19) United States
(12) Patent Application Publication
(10) Pub. No.: US 2011/0060912 A1
(43) Pub. Date: Mar. 10, 2011

(54) PASSWORD INPUTTING SYSTEM AND METHOD THEREOF

(75) Inventor: LUNG DAI, Tu-Cheng (TW)

(73) Assignee: HON HAI PRECISION INDUSTRY CO., LTD., Tu-Cheng (TW)

(21) Appl. No.: 12/755,496

(22) Filed: Apr. 7, 2010

(30) Foreign Application Priority Data
Sep. 10, 2009 (CN) 200910306830.6

(51) Int. Cl. G06F 21/00

(52) U.S. Cl. 713/183

(57) ABSTRACT

A method for inputting password with a touch sensitive display is provided. The method includes displaying a password array comprising a plurality of characters on a touch sensitive display, the plurality of characters being arranged in a first order, detecting if a permuting signal is received, generating a new password array comprising the a plurality of the characters when a permuting signal is received, the plurality of characters being arranged in a second order different from the first order, and displaying the generated new password array on the touch sensitive display to replace the displayed password array. A password inputting system using the method is also provided.

### BACKGROUND

1. Technical Field

The present disclosure relates to password inputting systems, and more particularly to a password inputting system and a method for inputting password.

2. Description of Related Art

A conventional password often includes numbers such as 0-9, and/or letters such as a-z or A-Z. However, input devices used for inputting a password are substantially similar, and locations of the numbers or the letters arranged in the input device are unchangeable. Accordingly, the password can easily be observed while inputting the password via the input devices.

Therefore, it is desired to provide a password inputting system and a method for overcoming the described shortcomings and deficiencies.

### BRIEF DESCRIPTION OF THE DRAWINGS

The components of the drawings are not necessarily drawn to scale, the emphasis instead being placed upon clearly illustrating the principles of the embodiments of the password inputting system. Moreover, in the drawings, like reference numerals designate corresponding parts throughout several views.

FIG. 1 is a block diagram of a password inputting system in accordance with an exemplary embodiment.

FIG. 2 is a schematic diagram showing a predetermined password array displayed by the password inputting system of FIG. 1 in accordance with an exemplary embodiment.

FIG. 3 is a schematic diagram showing another password array generated by the password inputting system of FIG. 1, the password array replaces the predetermined password array of FIG. 2.

FIG. 4 is a block diagram of a password inputting system in accordance with another exemplary embodiment.

FIG. 5 is a flowchart of a method for inputting a password in accordance with an exemplary embodiment.

### DETAILED DESCRIPTION

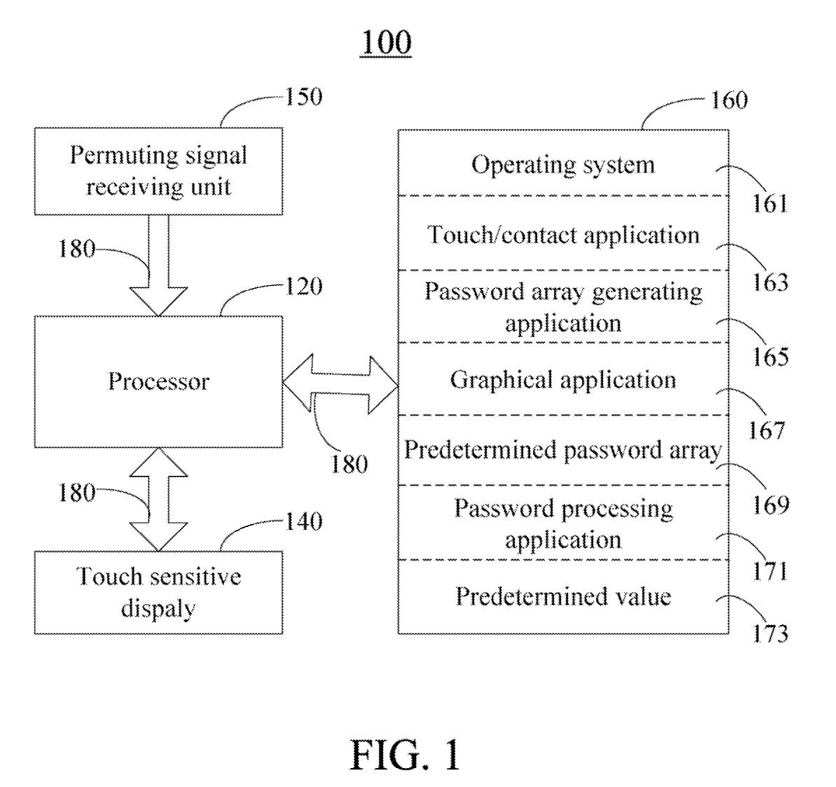

Referring to FIG. 1, a block diagram of a password inputting system 100 in accordance with an exemplary embodiment is shown. The password inputting system 100 includes a processor 120, a touch sensitive display 140, a permuting signal receiving unit 150, and a storage device 160, all interconnected via buses 180.

The processor 120 executes/runs various software components stored in the storage device 160 to perform various functions for the password inputting system 100, and controls operations of the password inputting system 100.

The touch sensitive display 140 provides both an output interface and an input interface between the password inputting system 100 and a user. The touch sensitive display 140 is operable to receive inputs/contacts by one or more means, for example, a stylus and/or by touch. In the embodiment, the user inputs password via the touch sensitive display 140. The touch sensitive display 140 may receive/detect the inputs/contacts using any of a plurality of touch sensitive technologies, including, but not limited to capacitive, resistive, infrared, and surface acoustic wave technologies. The touch sensitive display 140 is also operable to output visual data. The visual outputs may include text, graphics, video, and any combination thereof. The touch sensitive display 140 may use liquid crystal display (LCD) technology, or light emitting polymer display (LPD) technology, although other display technologies may be used in other embodiments.

The permuting signal receiving unit 150 is electrically connected to the processor 120. The permuting signal unit 150 is configured to generate permuting signals in response to user operations. The generated permuting signals are sent to the processor 120. The processor 120 processes the permuting signals to change password arrays displayed on the touch sensitive display 140. The permuting signal receiving unit 150 may be a special key and/or a menu item. The user can operate the special key and/or the menu item to input the operations for permuting the password arrays.

The storage device 160 includes one or more types of memories, such as a read only memory (ROM) and a random access memory (RAM). The storage device 160 may also store an operating system 161, a touch/contact application 163, a password array generating application 165, a graphical application 167, a predetermined password array 169, a password processing application 171, and a predetermined value 173 used for authenticating an inputted password from the touch sensitive display 140. The predetermined password array 169 is displayed on the touch sensitive display 140 when the processor 120 is triggered to perform operations of the password inputting system 100.

The operating system 161 (e.g., LINUX®, UNIX®, WINDOWS®, or an embedded operating system such as VxWorks®) includes various procedures, sets of instructions, software components and/or drivers for controlling and managing general system tasks (e.g., memory management, storage device control, and power management.) and facilitating communication between various hardware and software components.

The touch/contact application 163 includes various software components and/or set of instructions, which may be invoked/implemented by the processor 120 for detecting inputs/contacts with the touch sensitive display 140. More particularly, the touch/contact application 163 may be invoked/implemented for performing various operations related to detections of inputs/contacts with the touch sensitive display 140, such as determining if the inputs/contacts have occurred, and determining if the inputs/contacts have ended (i.e., if the inputs/contacts have stopped). In the embodiment, the touch/contact application 163 may be invoked/implemented for inputting the password such as numbers and/or letters according to detections of inputs/contacts with the touch sensitive display 140.

The password array generating application 165 includes a set of computing instructions, which may be implemented by the processor 120 for generating a new password array randomly if a permuting signal is received by the processor 120. In the embodiment, the password array includes ten numbers: 0-9. As the new password array is generated randomly, thus, the number of password array is P₁₀¹⁰. It is noteworthy that the password array can further include letters, or a combination of numbers and letters. For additional characters, such as for letters and numbers, the number of password array is greater than P₁₀¹⁰.

The graphical application 167 includes various software components and/or set of instructions, which may be implemented by the processor 120 for rendering and displaying graphical user interfaces (GUI) on the touch sensitive display 140. It should be noted that the GUI may include any object that can be displayed, including, text, web pages, icons (such as user interface objects including soft keys), digital images, videos, animations. In the embodiment, the GUI includes a password array. The user contact/operates the touch sensitive display 140 according to the password array, such that users can input correct character information, such as, numbers and/or letters.

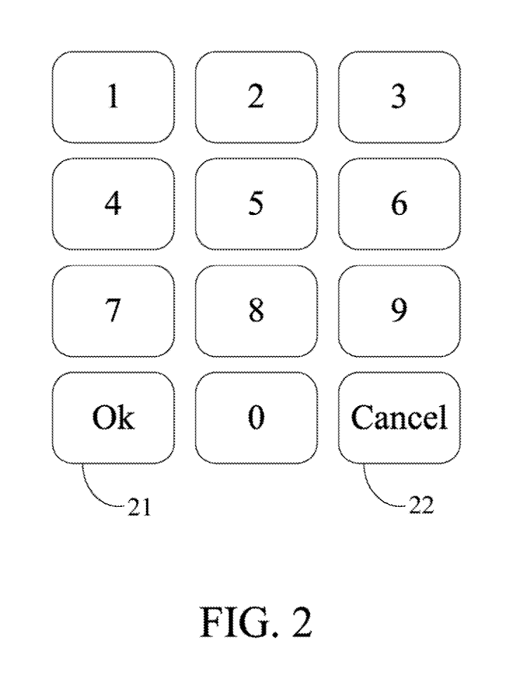

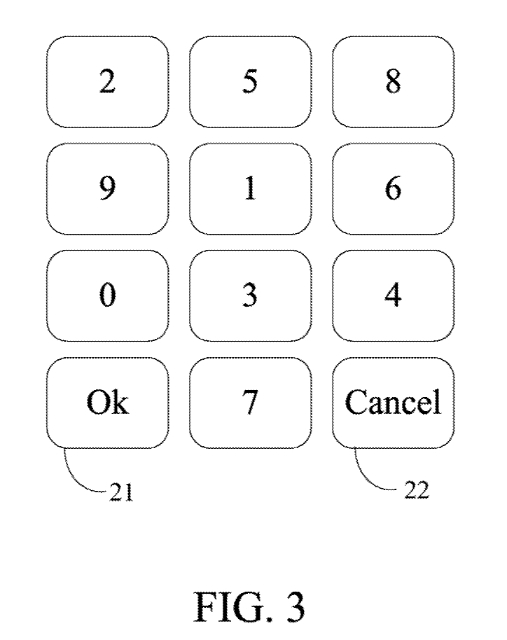

Referring to FIG. 2, in operation, when the password inputting system 100 is triggered to prompt for access/unlock operations (procedures), the graphical application 167 is implemented by the processor 120 to display the predetermined password array 169 on the touch sensitive display 140. The numbers of the predetermined password array 169 are arranged orderly. Referring to FIG. 3, when the processor 120 receives the permuting signal, the password array generating application 165 is implemented by the processor 120 to generate a new password array randomly, and the graphical application 167 is implemented by the processor 120 to display the generated new password array on the touch sensitive display 140 to replace the predetermined password array 169. Because the user contacts/operates the touch sensitive display 140 according to the new password array, thus, when user inputs next numeral, the position that user contacts/operates the touch sensitive display 140 may indicates different numbers, as a result, the password is protected from being observed via remembering the position that the user contacts/operates the touch sensitive display 140 when the user is inputting the password.

The password processing application 171 includes various software components and/or set of instructions, which may be invoked/implemented by the processor 120 for comparing an inputted password via the touch sensitive display 140 with the predetermined value 173, and granting an access when the inputted password satisfies the predetermined value 173.

Furthermore, the GUI further includes a confirm button 21 and a cancel button 22, such that the user can amend the inputted password. The confirm button 21 is configured to generate affirm signals according to detections of inputs/contacts with the touch sensitive display 140. The cancel button 22 is configured to generate cancel signals according to detections of inputs/contacts with the touch sensitive display 140.

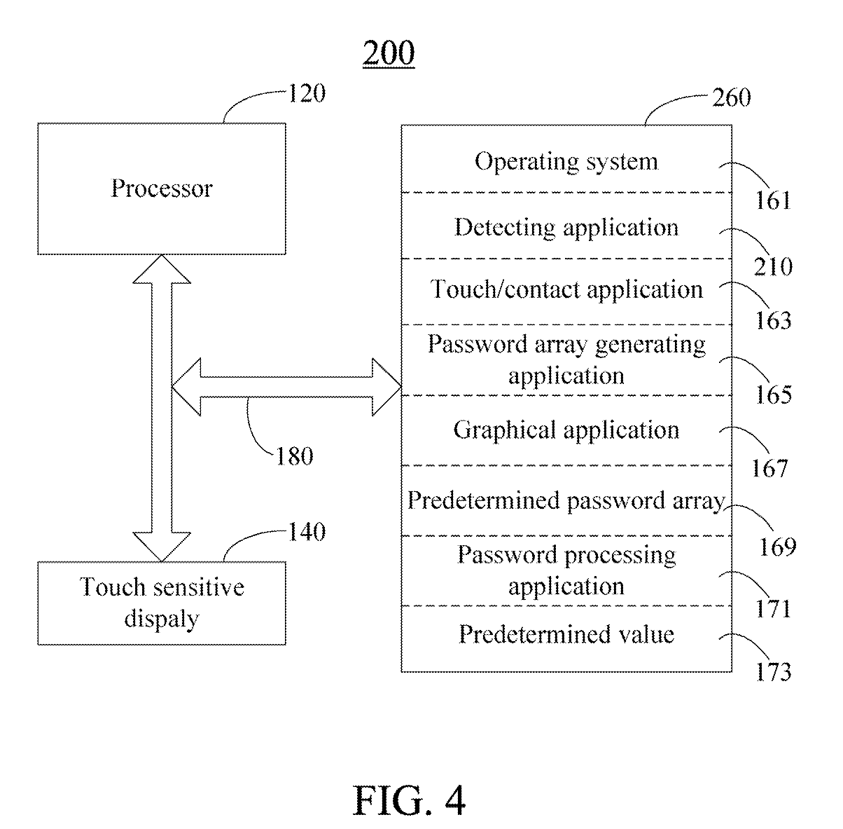

Referring to FIG. 4, a block diagram of a password inputting system 200 in accordance with another exemplary embodiment is shown. The password inputting system 200 is similar to the password inputting system 100. The difference between the password inputting system 100 and the password inputting system 200 is the following: the password inputting system 200 has no permuting signal receiving unit 150, but the storage device 260 thereof, further stores a detecting application 210. The detecting application 210 includes various software components and/or set of instructions, which may be implemented by the processor 120 for detecting whether the processor 120 receives a character for a password, and generating a permuting signal when the processor 120 receives a character. For example, a password is composed of 568957, according to a current password array A, the detecting application 210 is implemented by the processor 120 to generate a permuting signal when user inputs the first numeral ‘5’. The password array generating application 165 is implemented by the processor 120 to generate a new password array different from the current password array A randomly. The graphical application 167 is implemented by the processor 120 to display the generated new password array on the touch sensitive display 140 to replace the current password array A.

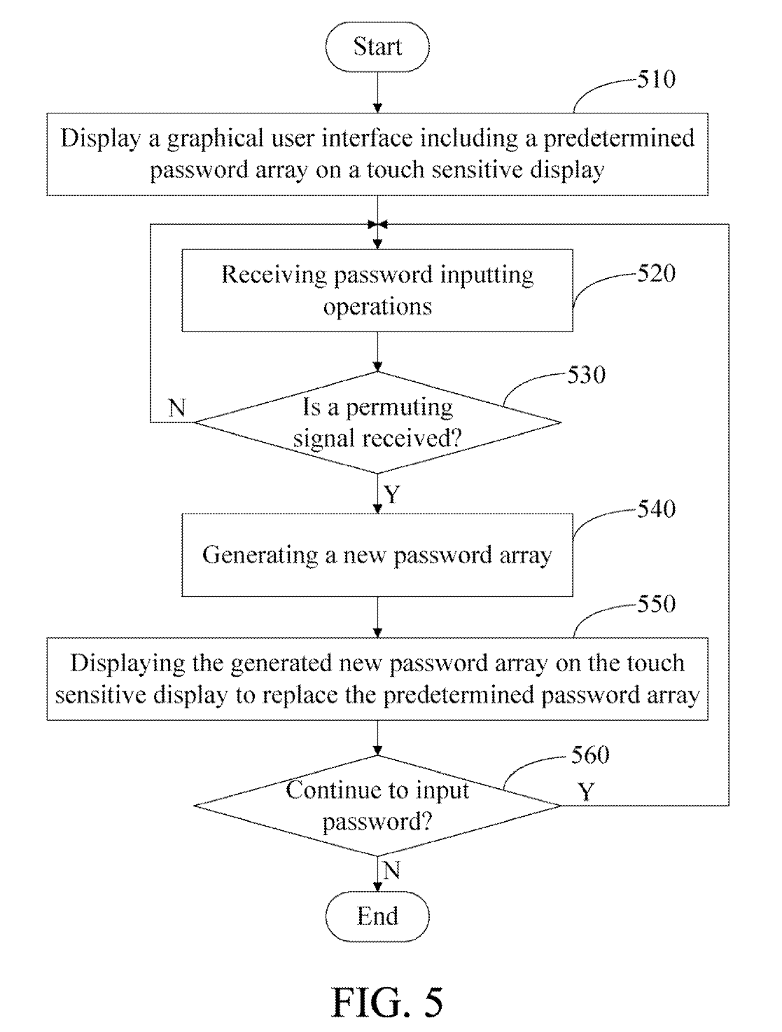

Referring to FIG. 5, a flowchart illustrating a method applied on the password inputting system 100 of FIG. 1 for inputting password is shown. The method includes following blocks, each of which is tied to various modules contained in the password inputting system 100 as shown in FIG. 1.

At block 510, in operation, the processor 120 invokes/implements the graphical application 167 to display a graphical user interface including the predetermined password array 169 on a touch sensitive display 140.

At block 520, the processor 120 invokes/implements the touch/contact application 163 to receive user's touches/contacts, thereby, inputting password.

At block 530, the processor 120 detects whether a permuting signal is received. If there is no permuting signal being received, the procedure returns to block 520, and if there is a permuting signal being received, the procedure goes to block 540. In one embodiment, the permuting signal is generated by operating a special key associated with the password inputting system 100. In another embodiment, the permuting signal is automatically generated each time after a single numeral or a single letter is inputted.

At block 540, the processor 120 invokes/implements the password array generating application 165 to generate a new password array randomly.

At block 550, the processor 120 invokes/implements the graphical application 167 to display the generated new password array on the touch sensitive display 140, such that the predetermined password array 169 is replaced by the generated new password array.

At block 560, the processor 120 determined whether the touch/contact application 163 is invoked to receive another character for password. If not, the procedure ends, and if the processor 120 receives another character, the procedure returns to block 520.

As described above, by virtue of the password inputting system 100 and the method for inputting password, user can change the password array displayed on the touch sensitive display 140, thereby, protecting the password more efficiently.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. A password inputting system, comprising:
a touch sensitive display;
a storage device storing a plurality of characters for composing password arrays, and a plurality of modules; and
a processor executing the plurality of modules;
wherein the plurality of modules comprises instructions executable by the processor to:
display a first password array comprising the plurality of characters on the touch sensitive display;
detect if a permuting signal is received;
generate a second password array with the plurality of characters being arranged in a different order upon detection that the permuting signal is received; and
display the second password array on the touch sensitive display to replace the first password array.

2. The password inputting system of claim 1, wherein the plurality of characters comprise numbers, letters, or any combination of the numbers and letters.

3. The password inputting system of claim 1, further comprising a permuting signal receiving unit, the permuting signal receiving unit configured for generating permuting signals in response to user operations for permuting the password array, and sending the generated permuting signals to the processor.

4. The password inputting system of claim 1, wherein the plurality of modules comprise a detecting application comprising instructions executable by the processor, the detecting application is implemented by the processor for detecting if the processor receives one of the plurality of characters for password, and generating a permuting signal when the processor receives one of the plurality of characters.

5. The password inputting system of claim 1, wherein the storage device further stores a predetermined password array, the plurality of modules further comprise instructions executable by the processor to:
display a predetermined password array on the touch sensitive display when the password inputting system is triggered to prompt for access/unlock operations.

6. The password inputting system of claim 1, wherein the storage device further stores a predetermined value, the plurality of modules further comprise instructions executable by the processor to:
compare an inputted password from the touch sensitive display with the predetermined value; and
grant an access when the inputted password satisfies the predetermined value.

7. A method for inputting password, the method comprising:
displaying a password array comprising a plurality of characters on a touch sensitive display, the plurality of characters being arranged in a first order;
detecting if a permuting signal is received;
generating another password array comprising of the a plurality of the characters when a permuting signal is received, the plurality of the characters being arranged in a second order different from the first order; and
displaying the another password array on the touch sensitive display to replace the displayed password array.

8. The method of claim 7, wherein the plurality of characters comprise numbers and/or letters.

9. The method of claim 7, further comprising:
generating permuting signals in response to user operations for permuting password array.

10. The method of claim 7, further comprising:
detecting if one of the plurality of characters for password is received; and
generating a permuting signal when one of the plurality of characters is received.

11. The method of claim 7, further comprising:
storing a predetermined password array; and
displaying the predetermined password array on the touch sensitive display when the password inputting system is triggered to prompt for access/unlock operations.
